(19) United States
(12) Patent Application Publication
(10) Pub. No.: US 2025/0238425 A1
(43) Pub. Date: Jul. 24, 2025

(54) SEARCH TABLE AND SEARCH JOB FOR SEARCH QUERY FOR WHICH MATCHING EVENTS ARE TO BE CONTINUALLY PROVIDED

(71) Applicant: MICRO FOCUS LLC, Wilmington, DE (US)

(72) Inventors: Mijung Kim, Santa Clara, CA (US); Puttali Hithalapura Basavaraj, Richmond, VA (US); Martin Fraser Arlitt, Ottawa (CA)

(73) Assignee: MICRO FOCUS LLC, Wilmington, DE (US)

(21) Appl. No.: 18/419,282

(22) Filed: Jan. 22, 2024

(51) Int. Cl. G06F 16/2455; G06F 16/2453

(52) U.S. Cl. CPC G06F 16/24568; G06F 16/24542

(57) ABSTRACT

A search table is instantiated for a search query for which matching events of the events stored in an events table are to be continually provided as new events are continually loaded into the events table. The matching events satisfy the search query. The search table is to store the matching events. A search job for the search query is generated. The search job is to be continually (i.e., periodically) run to retrieve the matching events stored in the events table that are not already stored in the search table and to insert the retrieved matching events in the search table. The search job is therefore continually (i.e., periodically) run, such that the matching events are continually (i.e., periodically) provided from the search table and not from the events table.

### BACKGROUND

A significant if not the vast majority of computing devices are globally connected to one another via the Internet. While such interconnectedness has resulted in services and functionality almost unimaginable in the pre-Internet world, not all the effects of the Internet have been positive. A downside, for instance, to having a computing device potentially reachable from nearly any other device around the world is the computing device's susceptibility to malicious cyberattacks that likewise were unimaginable decades ago. Additionally, in an enterprise or other organization having large numbers of such computing devices, the devices have to be properly configured in order for them to optimally communicate with other devices over the Internet and other networks.

### BRIEF DESCRIPTION OF THE DRAWINGS

FIG. 1 is a diagram of an example system for continually providing matching events for search queries.

FIG. 2A is a diagram of an example search query table for storing entries corresponding to search queries.

FIG. 2B is a diagram of an example search table for storing matching events for a search query.

FIG. 3 is a flowchart of an example method for adding an entry to a search query table when a new search query is created.

FIG. 4 is a flowchart of an example method for continually adding new matching events to a search table for a search query as new events are added to an events table.

FIG. 5 is a flowchart of an example method that is consistent with but more detailed than FIG. 4.

FIG. 6 is a diagram of an example performance of the method of FIG. 5.

FIG. 7 is a flowchart of an example method for continually updating a user interface for a search query to automatically display new matching events.

FIG. 8 is a flowchart of an example method for deleting an existing search query.

FIG. 9 is a flowchart of an example method for managing a search table for a search query.

FIG. 10 is a diagram of an example computing device.

### DETAILED DESCRIPTION

As noted in the background, a large percentage of the world's computing devices can communicate with one another over the Internet, which is generally advantageous. Computing devices like servers, for example, can provide diverse services, including email, remote computing device access, electronic commerce, financial account access, and so on. However, providing such a service can expose a server computing device to cyberattacks, particularly if the software underlying the services has security vulnerabilities that a nefarious party can leverage to cause the application to perform unintended functionality and/or to access the underlying server computing device.

Individual servers and other devices, including other network devices and computing devices other than server computing devices, may output log events indicating status and other information regarding their hardware, software, and communication. Such communication can include intra-device and inter-device communication as well as intra-network (i.e., between devices on the same network) and inter-network (i.e., between devices on different networks, such as devices connected to one another over the Internet) communication. The terminology log event is used generally herein, and encompasses all types of data that such devices, or hosts or sources, may output. For example, such data that is encompassed under the rubric of log events includes that which may be referred to as messages, as well as that which may be stored in databases or files of various formats.

To detect potential security vulnerabilities and potential cyberattacks by nefarious parties, as well as to detect other types of anomalies, such as device misconfiguration and operational and/or business issues, voluminous amounts of data in the form of such log events may therefore be collected, and then analyzed in an offline or online manner to identify such anomalies. An enterprise or other large organization may have a large number of servers and other devices that output log events. The log events may be consolidated so that they can be analyzed en masse. Some anomalies, for instance, may be more easily detected or may only be able to be detected by analyzing interrelationships among the log entries of multiple devices, or sources. Analyzing the log events of just one computing device may not permit such anomalies to be detected.

The log events from the disparate servers and other devices may be stored within a database, such as the Vertica database. The log events may be stored within a database table. To distinguish the database table that stores all the log events collected from servers and other devices from other database tables described herein, this table is referred to herein as the events table. As new log events are output by servers and other devices, they are thus loaded into the events table. To analyze the log events to identify anomalies, search queries can be performed against the events table. For instance, by running a search query, the log events stored in the events table that match the query are retrieved, and these matching events can then be analyzed manually by a user or automatically in order to determine whether they represent an anomaly.

Since new log events are continually loaded into the events table as they are output by servers and other devices, users may want to run queries for which matching events are to be continually provided. For example, a user interface may be displayed that shows the most recent matching events for a search query, such that as new matching events are loaded into the events table, they are automatically added to the user interface and the oldest matching events may be removed from the user interface. Such search queries are known as “real-time” queries, although this terminology is a bit of a misnomer in that new matching events are not immediately provided as they are loaded into the events table; rather, a real-time query is frequently run to capture matching new events soon after they have been added to the events table.

Database performance can suffer when search queries are continually run against the events table as new events are continually loaded into the events table such that the events table becomes very large over time. For example, when a user interface is automatically updated with matching events for a search query as new events are loaded into the events table, a user may identify a potential anomaly and run follow-on queries to further winnow down the matching events to better investigate the issue. The performance of such follow-on queries against the events table may not be as fast as desired, impeding the user's ability to quickly determine whether an issue has actually occurred.

Techniques described herein ameliorate these and other issues. In particular, the techniques provide for a database architecture that improves performance of search queries for which matching events are to be continually provided as new events are continually loaded into an events table. Rather than continually providing the matching events for such a search query from the events table directly, they are provided from a search table for the search query. Whereas the events table stores all events that have been output from servers and other devices, the search table stores just those events that satisfy the search query, and further just the newer matching events in this respect. Such an architecture has been demonstrated to improve database performance for search queries that are continually run as new events are continually loaded into the events table.

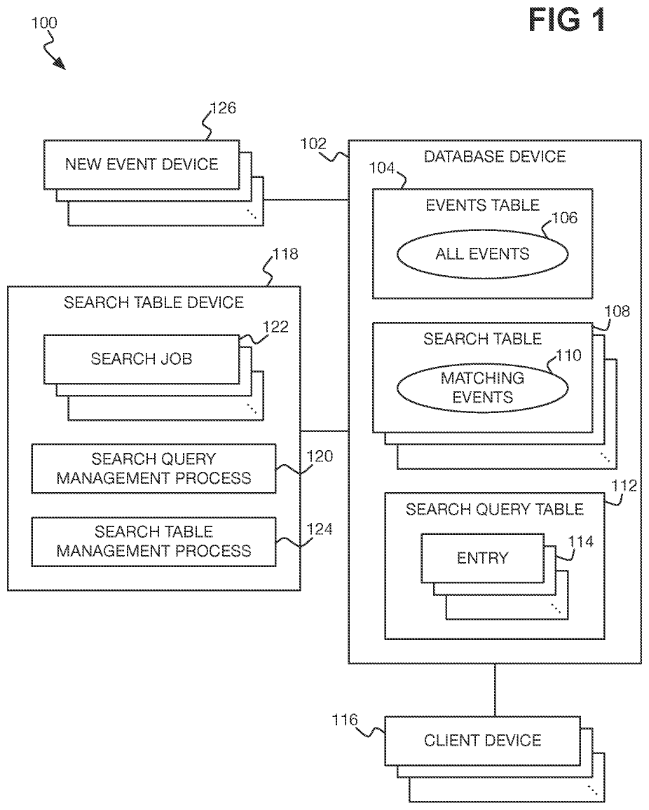

FIG. 1 shows an example system 100. The system 100 includes a database device 102. The database device 102 may be implemented as one or more discrete computing devices, and maintains the database used to store log events as they are output by servers and other devices, so that the log events can be analyzed to identify anomalies. The database device 102 specifically stores an events table 104, which is a discrete database table that stores all events 106 that have been output by servers and other devices and subsequently loaded into the table 104. New events 106 are continually loaded into the events table 104 as they are generated at the servers and other devices. Older events 106 may be periodically removed from the events table 104 to ensure that the table 104 does not take up too much storage space.

The database device 102 also stores search tables 108. Each search table 108 is a discrete database table for a corresponding search query that is to be continually run (i.e., for a “real-time” search query as this terminology is used as discussed above), such that there is a search table 108 for each different search query. The search table 108 stores matching events 110 for its corresponding search query. The matching events 110 are a subset of all the events 106 stored in the events table 104. The matching events 110 are those of the events 106 that satisfy the search query in question, and further may be just newer of the events 106 that satisfy the search query. As new events 106 are loaded into the events table 104, those matching a search query are continually retrieved from the events table 104 and added to the search table 108 as new matching events 110.

The database device 102 stores a search query table 112 as well. The search query table 112 is a discrete database table for all the search queries. Therefore, while there is a separate search table 108 for each search query, there is one search query table 112 for all the search queries. The search query table 112 stores metadata regarding the search queries. Specifically, the search query table 112 has entries 114 respectively corresponding to the search queries. Each entry 114 of the search query table 112 stores metadata for a corresponding search query.

The system 100 includes one or multiple client devices 116 communicatively connected to the database device 102. The client devices 116 may each be a computing device operated by a user that is interested in performing analysis against the events 106 loaded into the events table 104 to identify anomalies. The client devices 116 may be desktop, laptop, or notebook computers, as well as other types of computing devices, such as smartphones, tablet computing devices, and so on. A user may enter a search query for which matching events 110 are to be continually provided at a client device 116, and the device 116 may continually update a user interface with matching events 110 as new events 106 are loaded into the events table 104.

A search query for which matching events 110 are to be continually provided is thus generated at a client device 116, and the client device 116 displays a user interface for the query that is populated with these matching events 110. Specifically, when a new search query is generated at a client device 116, the client device 116 adds a new entry 114 for the search query in the search query table 112. The client device 116 continually retrieves new matching events 110 from the search table 108 instantiated for the search query, and automatically displays them in a user interface corresponding to the search query. When the search query is deleted, the client device 116 removes the entry 114 from the search query table 112, and the search table 108 for the query is deleted, as described in more detail later in the detailed description.

The system 100 includes a search table device 118. The search table device 118 may be implemented as one or more discrete computing devices. The search table device 118 may be the database device 102. That is, the database device 102 and the search table device 118 may be the same device, as opposed to the device 118 being a different, separate device from the device 102. In another case, however, the database device 102 and the search table device 118 may be separate, different devices. In this case, the search table device 118 is communicatively connected to the database device 102, and may not be communicatively connected to the client devices 116.

The search table device 118 runs a search query management process 120, which manages search queries. Specifically, the search query management process 120 detects when an entry 114 for a new search query has been added to the search query table 112, and responsively instantiates a search table 108 for the search query in which to store matching events 110 that satisfy the query. The search query management process 120 further schedules a search job 122 for the search query that is to be continually run. The search table device 118 thus runs search jobs 122 that respectively correspond to the search jobs for which there are entries 114 in the search query table 112.

The first time that the search job 122 for a search query is run, the search job 122 retrieves from the events table 104 more recent events 106 (e.g., newer than a newness threshold) that satisfy the search query, and inserts them into the search table 108 for the search query to initially populate the search table 108 with matching events 110. Every subsequent time the search job 122 is run, the search job 122 retrieves new events 106 satisfying the search query that have been loaded into the events table 104, and inserts them into the search table 108 for the search query to update the search table 108 with new matching events 110.

The search table device 118 also runs a search table management process 124, which manages the search tables 108 for the search queries. Specifically, the search table management process 124 periodically removes the oldest matching events 110 from each search table 108 so that each search table 108 does not store matching events 110 older than a specified oldness threshold. The search management process 124 also periodically removes the oldest matching events 110 from each search table 108 so that each search table 108 does not store more than a specified maximum number of matching events 110.

The system 100 includes one or multiple new event devices 126, which can each be implemented as one or more discrete computing devices. The new event devices 126 may be the same device as the database device 102. The new event devices 126 may instead be separate, different devices from the database device 102, in which case the devices 126 are communicatively connected to the database device 102. The new event devices 126 continually receive or retrieve log events as they are output by servers and other devices, and loads (i.e., inserts) such new events 106 into the events table 104.

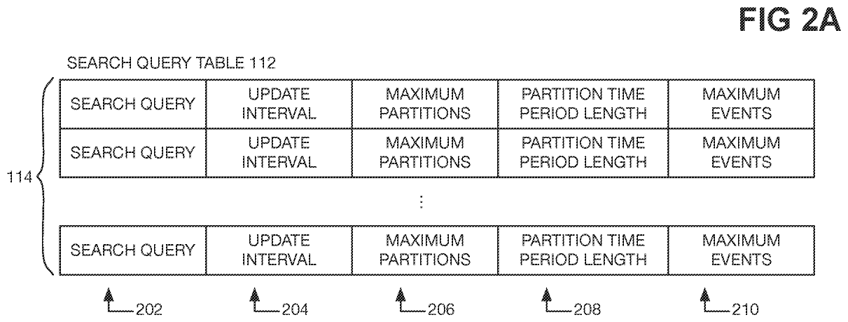

FIG. 2A shows the search query table 112 in detail. The entries 114 of the search query table 112 respectively correspond to search queries 202. Each entry 114 includes its corresponding search query 202, and as depicted in the figure, also includes other metadata regarding the search table 108 for its corresponding search query 202. Specifically, each entry 114 can include an update interval 204 indicating how often the search table 108 for its search query 202 is to be updated to retrieve new events 106 from the events table 104 that match the query 202 and insert them into the search table 108 as new matching events 110. For example, the update interval 204 may be specified as a specified number of seconds or other length of time. The update interval 204 thus indicates how often the search job 122 for the search query 202 is run.

Each entry 114 can include a maximum number 206 of partitions that the search table 108 for the corresponding search query 202 can have; the partition time period length 208 encompassed by each such partition; and the maximum number 210 of matching events 110 that the search table 108 is to store. The search table 108 stores the matching events 110 for a corresponding search query 202 by their loading times in the events table 104 (and not by the loading times when they were loaded in the search table 108). That is, when an event 106 is loaded into the events table 104, this loading time is stored in the events table 104 as well. When an event 106 is retrieved from the events table 104 and inserted into the search table 108, this same loading time is also stored in the search table 108.

The search table 108 for a search query 202 is partitioned over consecutive time periods that are each equal to the partition time period length 208. Each partition stores the matching events 110 that have loading times within the time period to which partition corresponds. The number of matching events 110 in any given partition is variable, since during some time periods there can be more events 106 loaded into the events table 104 that match the search query 202 in question than during other time periods.

Since the maximum number 206 of partitions of the search table 108 is specified, this means that the oldest matching events 110 stored in the search table 108 are no older than the maximum number 206 multiplied by the partition time period length 208. That is, each partition corresponds to a time period having a length equal to the partition time period length 208, which means that the oldest such partition corresponds to the time period that occurred the maximum number 206 of partitions times the partition time period length 208 ago. For instance, if the maximum number 206 of partitions is N, and the partition time period length 208 is ptl, then events 110 older than ptl*N are removed from the search table 108.

However, since the number of matching events 110 in any given partition of the search table 108 for a search query 202 is variable, this means that specification of the maximum number 206 of partitions does not constrain the total number of matching events 110 that can be stored in the search table 108 at any given time. Rather, the maximum number 210 of matching events 110 constrains how many matching events 110 the search table 108 is to store at any given time. Therefore, once the maximum number 210 of events 110 has been reached, then the oldest events 110 are removed from the search table 108 until the table 108 stores no more than the maximum number 210 of events 110.

The metadata is depicted in the example as being individually stored for each search table 108 insofar as each entry 114 includes the metadata. Therefore, different search tables 108 can have different update intervals 204, maximum numbers 206 of partitions, and so on. However, all the search tables 108 may instead have the same metadata, such that the same update interval 204, maximum number 206 of partitions, and so on, are used for every search table 108. In this case, the metadata is not stored in each entry 114, but rather once in a separate entry within the search query table 112.

FIG. 2B shows the search table 108 for a corresponding search query 202 in detail. The matching events 110 are stored in the search table 108 over partitions 252. As has been described, the partitions 252 correspond to consecutive time periods that are each equal to the partition time period length 208. The matching events 110 each include a loading time 254 and a unique identifier 256. As has also been described, the loading time 254 of a matching event 110 is the time at which the event 110 was loaded into the events table 104. Therefore, each partition 252 stores the matching events 110 for which the loading times 254 are within the time period to which that partition 252 corresponds. The unique identifier 256 of a matching event 110 uniquely identifies the event 110 as compared to other events 106 stored in the events table 104.

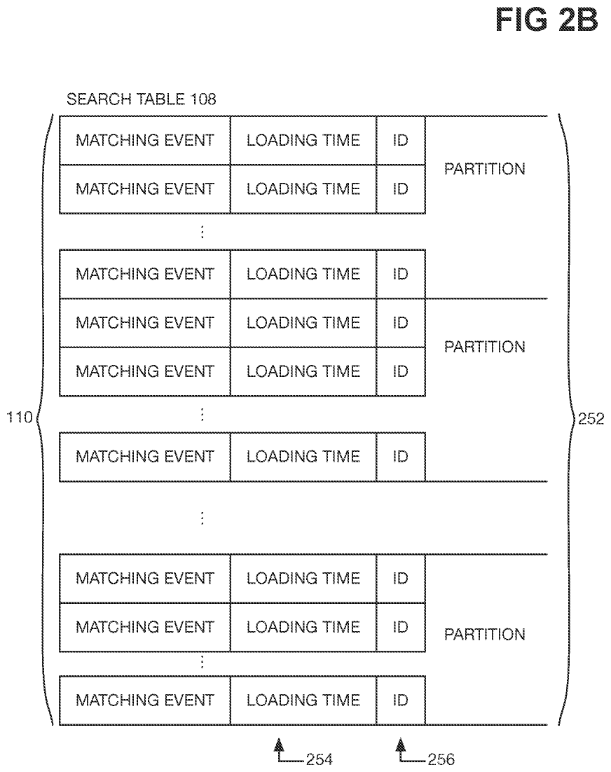

FIG. 3 shows an example method 300 that is performed for a new search query 202, and begins with the client device 116 generating the new search query 202 (302). For example, a user may create the search query 202 at the client device 116. The client device 116 may thus a new entry 114 for the search query 202 within the search query table 112 (304). The metadata for the search query 202 may be specified by the user when the entry 114 is added to the search query table 112, or default values for the metadata may be stored for the search query 202 in the search query table 112.

The search query management process 120 running on the search table device 118 detects the addition of the entry 114 for the search query 202 (306), and instantiates a search table 108 for the search query 202 (308). When instantiated, the search table 108 is empty and thus initially has no entries. That is, no matching events 110 are stored in the search table 108 when the search table 108 is instantiated, even though there may be events 106 stored in the events table 104 that satisfy the search query 202.

The search query management process 120 generates a search job 122 for the search query 202 (310), and then schedules execution of the search job 122 so that it is continually (i.e., periodically) run (312) so long as the search query 202 exists. The search job 122 is continually run to retrieve events 106 stored in the events table 104 that are not already stored in the search table 108, and add such matching events 110 to the search table 108. Therefore, as new events 106 are continually loaded into the events table 104, new such matching events 110 are inserted into the search table 108. The search job 122 is run at the update interval 204 specified for the search query 202.

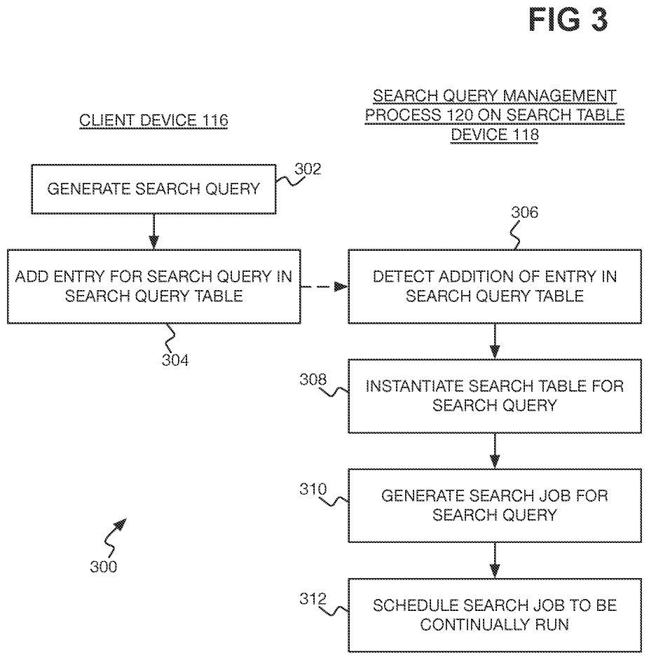

FIG. 4 shows an example method 400 that is performed when the search job 122 for a search query 202 is continually run at its update interval 204. As noted above, when the search table 108 for the search query 202 is instantiated—and thus before the search job 122 is run—the search table 108 is empty. Therefore, the first time the search job 122 is run (402), the search job 122 retrieves all matching events 110 stored in the events table 104 (i.e., all the events 106 satisfying the search query 202) that are newer than a newness threshold (404), and inserts them into the search table 108 (406) to initially populate the search table 108.

The newness threshold can correspond to the specified maximum number 206 of partitions 252 the search table 108 is to have and the specified partition time period length 208 of each partition 252. For example, since matching events 110 having loading times 254 older than the maximum number 206 of partitions 252 multiplied by the partition time period length 208 are removed from the search table 108, the newness threshold can correspond to this multiplicative product.

Each subsequent time the search job 122 is run (408), the search job 122 retrieves the matching events 110 stored in the events table 104 (i.e., the events 106 satisfying the search query 202) that are newer than the newest matching event 110 already stored in the search table 108 (410), and inserts them into the search table 108 (412). Therefore, new matching events 110 are continually inserted into the search table 108 as new events 106 are continually loaded into the events table 104.

The search jobs 122 for the search queries 202 can be performed in parallel. Furthermore, each time a given search job 122 is run, the events 106 retrieved from the events table 104 that match the corresponding search query 202 can be divided into chunks, and the chunks of such matching events 110 inserted into the search table 108 in question in parallel. The number of chunks may be specified, such that the number of matching events 110 in each chunk depends on how many events 106 are retrieved, or the number of matching events 110 in each chunk may be specified, such that the number of chunks depends on how many events 106 are retrieved.

When a matching event 110 is inserted into the search table 108, the event 110 is stored in one of the partitions 252 according to its loading time 254. Specifically, the matching event 110 is stored in the partition 252 that corresponds to the time period encompassing the loading time 254 of the matching event 110. However, if the matching event 110 has a loading time 254 newer than the most recent time period of any partition 252, a new partition 252 is added to the search table 108. Therefore, as the search job 122 is continually run, new partitions 252 are added to the search table 108 in correspondence with the loading times 254 of the matching events 110 to be inserted into the search table 108.

As has been noted, new events 106 are continually loaded into the events table 104 as servers and other devices output the events 106. The new events 106 may be loaded into the events table 104 in batches at a loading time interval, which is equal to or less than the update interval 204 of any search table 108. The loading time 254 of each event 106 loaded into the events table 104 in a given loading time interval is identical. However, in certain cases, some of these events 106 may not be immediately retrievable from the events table 104, even though other of the events 106 are, due to race conditions. This means that if the search job 122 is run soon after the loading time 254 of these events 106, not all of the events 106 may be retrieved from the events table 104, and thus not all of them may be inserted into the search table 108.

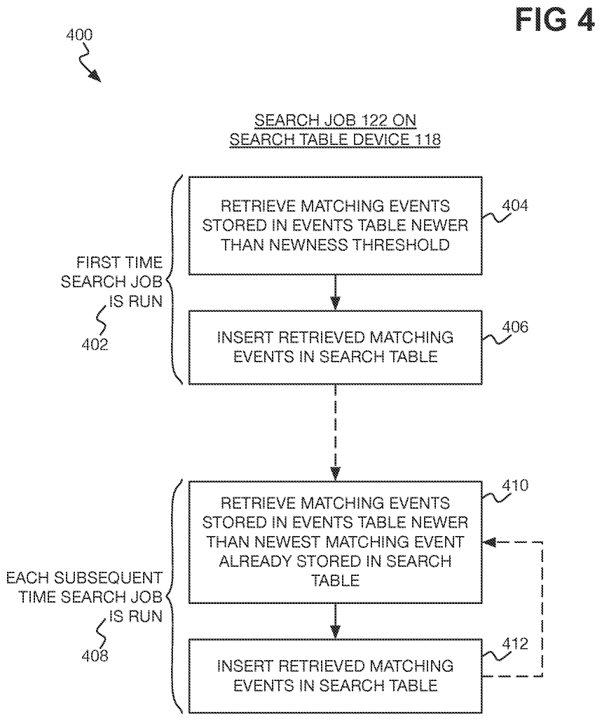

FIG. 5 shows an example method 500 that is performed when the search job 122 for a search query 202 is run each time subsequent to the first time it is run (408). The method 500 ensures that the search job 122 will not miss any events 106 satisfying the search query 202 when inserting matching events 110 into the search table 108, even if they are not immediately retrievable from the events table 104. The method 500, in other words, accounts for race conditions that may occur. The method 500 further ensures that the search job 122 will not duplicatively insert matching events 110 into the events table 108.

The search job 122 sets a maximum loading time to the loading time 254 of the newest matching event 110 already stored in the search table 108 (502). That is, the maximum loading time is the most recent loading time 254 of any matching event 110 already stored in the search table 108. The search job 122 then retrieves the events 106 stored in the events table 104 that satisfy the search query 202 (and thus are matching events 110) which have loading times 254 more recent than the maximum loading time that has been set (504). That is, each event 106 in the events table 104 matching the search query 202 and that has a loading time 254 greater than the maximum loading time is retrieved.

The events 106 retrieved in 504 may then be inserted into the search table 108 as new matching events 110 at this time (506). The identifiers 256 of these matching events 110 may not have to first be compared to the identifiers 256 of the matching events 110 already stored in the search table 108 to ensure that duplicates are not added to the search table 108. In such cases, this is because each new matching event 110 cannot already be in the search table 108 since its loading time 254 is greater than the maximum loading time and thus the loading time 254 of every matching event 110 already stored in the search table 108. However, in some types of databases, duplicate events 106 may be stored in the events table 104, such that the identifiers 256 of the matching events 110 may be compared to the identifiers 256 of the events 110 already stored in the search table 108 to ensure that duplicates are not added. That is, the identifiers 256 are checked to prevent any duplicate events 106 in the events table 104 from being propagated to the search table 108.

The search job 122 then retrieves the events 106 stored in the events table 104 that satisfy the search query 202 (and thus are matching events 110) which have loading times 254 that are greater than the maximum loading time (set in 506) minus the loading time interval (at which new events 106 are loaded into the events table 104), and that are less than or equal to the maximum loading time (508). That is, each event 106 in the events table 104 having a loading time 254 no older than the maximum loading time and more recent than the maximum loading time minus the loading time interval is retrieved. The events 106 retrieved in 508 will include any events 106 that were not retrieved in 504 the prior time the search job 122 was run because the events 106 were not yet retrievable from the events table 104 at that time.

Those of the events 106 retrieved in 508 that are not already in the search table 108 are then inserted into the search table 108 as new matching events 110 (510). The identifiers 256 of the events 106 may be used to identify which events 106 are not already stored in the search table 108 to ensure that no duplicates are added. This is because the events 106 retrieved in 508 can include events 106 that were retrieved in 504 the prior time the search job 122 was run as well as events 106 that were not yet retrievable from the events table 104. Therefore, comparing the identifier 256 of each event 106 retrieved in 508 to verify it is not yet in the search table 108 ensures that no event 106 is duplicatively inserted into the search table 108.

In the example, each subsequent time the search job 122 is run (408), the process for inserting new matching events 110 into the search table 108 can be performed twice: in 506 to insert the events 106 retrieved in 504 (if events 106 have been retrieved in 504), and in 510 to insert the events 106 retrieved in 508 (if events 106 have been retrieved in 508) that are not already stored in the search table 108. Instead, the process for inserting new matching events 110 into the search table 108 each subsequent time the search job 122 is run (408) just once, to insert the events 106 retrieved in 504 as well as the events 106 retrieved in 508 that are not already stored in the search table 108.

Furthermore, in the example, each subsequent time the search job 122 is run (408), the process for retrieving events 106 the events table 104 may be performed twice: in 504 to retrieve the matching events 106 having loading times greater than the maximum loading time set in 502, and in 508 to retrieve the matching events 106 having loading times greater than the maximum loading time minus the loading time interval and less than or equal to the maximum loading time. Instead, however, the process for retrieving events 106 from the events table 104 may be run once, to retrieve the events 106 that satisfy the search query 202 and which have loading times greater than the maximum loading time set in 502 minus the loading time interval.

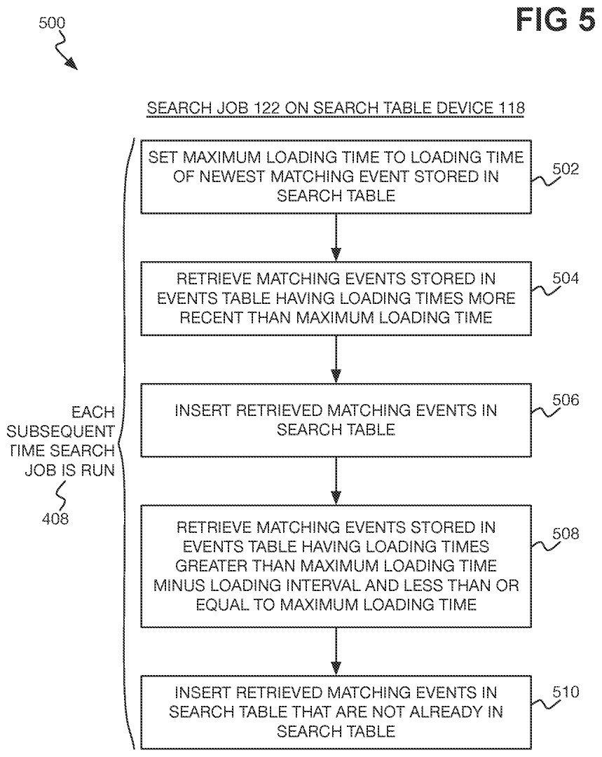

FIG. 6 shows example performance of the method 500. Events 106 are loaded into the events table 104 at times et1, et2, et3, et4, and so on, at the loading time interval. Therefore, et2 minus et1 is equal to the loading time interval, et3 minus et2 is equal to the loading time interval, et4 minus et3 is equal to the loading time interval, and so on. Furthermore, matching events 110 are inserted into the searching table 108 at times st1, st2, and so on, at the update interval 204. Therefore, st2 minus st1 is equal to the update interval 204, and so on. The update interval 204 is equal to or greater than the loading time interval. Furthermore, in the example, time st1 occurs soon after et2, and time st2 occurs soon after et4.

At time et1, the search table 108 already stores a single matching event 600 with loading time LT0 in the example. Therefore, LT0 is less than et1. At time et1, a new event 602 that satisfies the search query 202 is loaded into the events table 104, such that the new event 602 has loading time LT1 equal to et1 (and thus greater than LT0). At subsequent time et2, events 604 and 606 are loaded into the events table 104, such that both events 604 and 606 have loading time LT2 equal to et2.

When the search job 122 is run at time st1, the maximum loading time is set in 502 to LT0, which is the maximum loading time of the only matching event 600 stored in the search table 108. However, just events 602 and 604 are retrieved from the events table 104 in 504 and therefore are inserted as respective matching events 602′ and 604′ into the search table 108 in 506. The event 602 has loading time LT1 greater than LT0, which is why it is retrieved. However, even though the loading time LT2 of both events 604 and 606 is also greater than LT0, only event 604 is retrieved. The event 606, by comparison, may have been loaded at loading time LT2, but may not actually be retrievable at time st1, which occurs soon after time et2. Further, no events 106 are retrieved in 508 and thus no events 110 are inserted in 510, since there is no such event having a loading time 254 greater than LT0 minus the loading time interval and less than or equal to LT0.

At time et3, a new event 608 that satisfies the search query 202 is loaded into the events table 104, such that the new event 608 has loading time LT3 equal to et3 (and thus greater than LT2). At subsequent time et4, no events 106 are loaded into the events table 104 that satisfy the search query 202. When the search job 122 is run next at time st2, the maximum loading time is set in 502 to LT2, which is the maximum loading time of the newest matching event 604′ stored in the search table 108. The matching event 604′ is newer than the matching event 602′ because its loading time LT2 is greater than the loading time LT1 of event 602′. Similarly, the matching event 604′ is newer than the matching event 600 because LT2 is greater than the loading time LT0 of the event 600.

The event 608 is retrieved from the events table 104 in 504 and therefore is inserted as matching event 608′ into the search table 108 in 506. The event 608 has loading time LT3 greater than LT2, which is why it is retrieved. Next, the events 604 and 606 are retrieved from the events table 104 in 508, but just the event 606 is inserted (as matching event 606′) into the search table 108 in 510 because the event 604 is already stored in the search table 108 (as matching event 604′). The events 604 and 606 are both retrieved in 504 because they each have a loading time LT2 greater than the maximum loading time minus the loading time interval and less than or equal to the maximum loading time. Note the maximum loading time was set to LT2, such that each of the events 604 and 606 has a loading time LT2 equal to the maximum loading time.

The example of FIG. 6 illustrates how an event 106 (e.g., the event 606) has a loading time 254 (e.g., LT2=et2) that should result in its being retrieved from the search table 104 in 504 when the search job 122 is run (e.g., at st1>LT2), but is not because it not yet retrievable from the search table 104 at that time for whatever reason. The example illustrates how such an event 106 (e.g., the event 606) will, however, be retrieved from the search table 104 in 508 a subsequent time the search job 122 is run (e.g., at st2>st1), such that it will still be inserted into the search table 108 (e.g., as the matching event 606′).

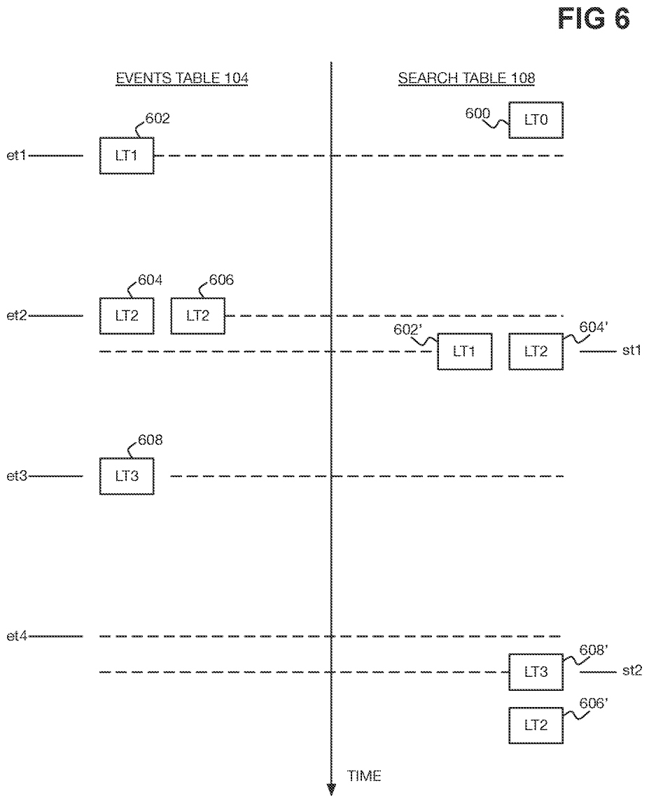

FIG. 7 shows an example method 700 that is continually performed at the client device 116 that generated a search query 202, as the search job 122 is continually run on the search table device 118 to update the search table 108 for the search query 202 and thus as new events 106 are continually loaded into the events table 104. The client device 116 retrieves new matching events 110 from the search table 108 (702). That is, the client device 116 retrieves matching events 110 stored in the search table 108 that the client device 116 has not previously retrieved. The client device 116 continually updates a user interface for the search query 202 that is populated with matching events 110 from the search table 108, by automatically displaying the new matching events 110 retrieved in 702 in the user interface (704). Therefore, the user interface for the search query 202 is updated as matching events 110 are continually provided from the search table 108.

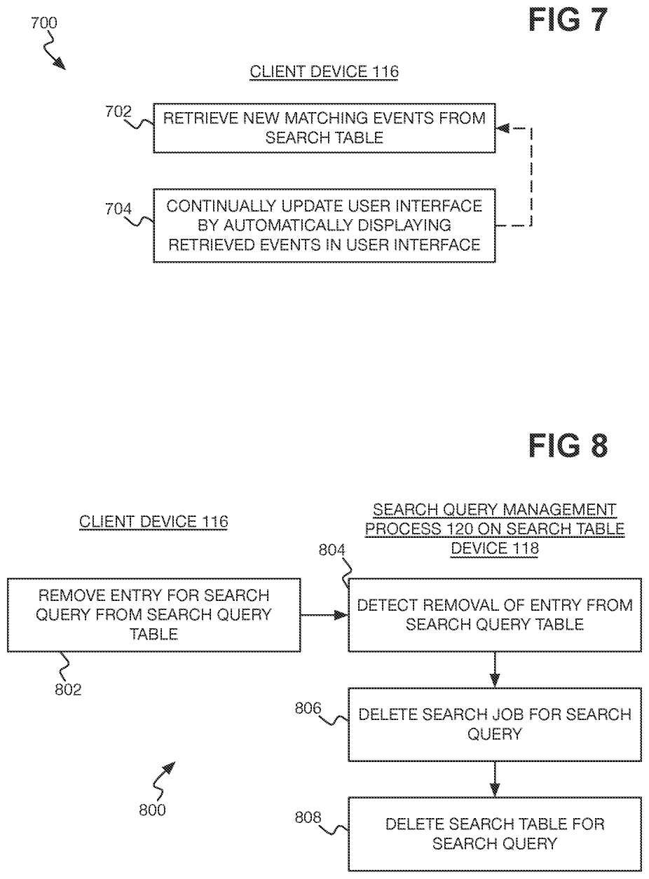

FIG. 8 shows an example method 800 that is performed when an existing search query 202 is deleted. For example, a user may decide to delete the search query 202 by closing the user interface (i.e., by causing it to no longer being displayed) on the client device 116. The client device 116 accordingly may remove the entry 114 for the search query 202 from the search query table 112 (802). The search query management process 120 running on the search table device 118 can detect the removal of this entry 114 (804), and responsively terminates and deletes the search job 122 for the search query 202 (806) and then may delete the search table 108 for the search query 202 (808).

In the search table 108 for a search query 202 that still has an entry 114 in the search query table 112 is deleted, the search query management process 120 may detect deletion of the search table 108 and in response remove the corresponding entry 114 from the search query table 112. For instance, the search table 108 for a search query 202 may be managed by the client device 116. Therefore, if the client device 116 deletes the search table 108, the search query management process 120 may be responsible for removing the corresponding entry 114 from the search query table 112.

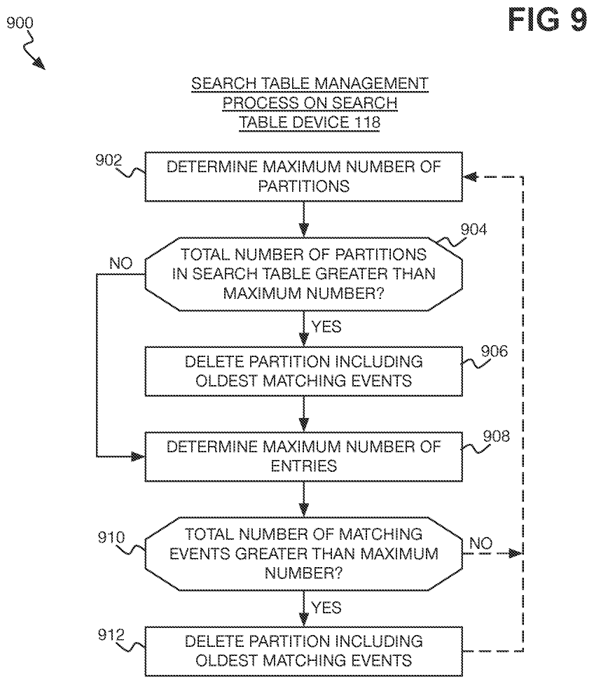

FIG. 9 shows an example method 900 for managing the search table 108 for a search query 202. The search table management process 124 running on the search table device 118 performs the method 900. The method 900 is performed for the search query 202 corresponding to each entry 114 stored in the search query table 112. The search table management process 124 may periodically perform the method 900 for the search queries 202 corresponding to all the entries 114 stored in the search query table 112, by periodically traversing the search query table 112 and individually performing the method 900 for the search query table 112 for each entry 114. The search table management process 124 may instead perform the method 900 for a search query 202 each time matching events 110 are inserted in the search table 108.

The search table management process 124 determines the maximum number 206 of partitions 252 of the search table 108 for a search query 202 (902), such as by retrieving this information from the search query table 112. In response to determining that the total number of partitions 252 of the search table 108 is greater than the maximum number 206 (904), the search table management process 902 deletes the partition 252 having the oldest matching events 110 (906). This partition 252 is that which includes the matching event 110 having the smallest and thus oldest loading time 254 of any matching event 110 in the search table 108. The partition 252 is deleted in 906 regardless of the number of matching events 110 it includes.

The search table management process 124 runs asynchronously to the loading of events 106 into the events table 104 and the insertion of matching events 110 into the search table 108. This means that multiple partitions 252 may be added to the search table 108 between consecutive times that the process 124 is run. Therefore, more than one of the oldest partitions 252 may have to be deleted from the search table 108 when the process 124 is run so that the total number of partitions 252 is no greater than the maximum number 206.

The search table management process 902 also determines the maximum number 210 of matching events 110 of the search table 108 (908), such as by similarly retrieving this information from the search query table 112. In response to determining that the total number of matching events 110 stored in the search table 108 is greater than the maximum number 210 (910), the search table management process 902 deletes the partition 252 having the oldest matching events 110 (912). This partition 252 is also deleted in 912 regardless of the number of matching events 110 it includes. More than one of the oldest partitions 252 may have to be deleted before the total number of matching events 110 stored in the search table 110 is no greater than the maximum number 210.

In the examples that have been described, each time a client device 116 creates a search query 202, a corresponding entry 114 is added to the search query table 112, a corresponding search table 108 is instantiated, and a corresponding search job 122 is generated and continually run. However, multiple client devices 116 may create similar or identical search queries 202. This means that there can be multiple entries 114 and multiple search tables 108 for what is effectively the same search query 202, and likewise that multiple search jobs 122 are generated and continually run for what is effectively the same search query 202.

In another example implementation, then, before an entry 114 for a search query 202 is added to the search query table 112, whether there is already an entry 114 for a similar or identical search query 202 in the search query table 112 is determined. This determination may be performed by the client device 116 or by the search table device 118. In the latter case, the client device 116 may, for instance, submit a search query 202 to the search table device 118 (such that the devices 116 and 118 have to be communicatively connected), and the search table device 118 is responsible for adding new entries 114 to the search query table 112.

If when a new search query 202 is created there is already an entry 114 in the search query table 112 for a similar or identical search query 202 (which may have been created by a different client device 116), then an entry 114 for the new search query 202 is not created. Therefore, a new search table 108 is not generated, and a new search job 122 is not created. Rather, the search table 108 for the older search query 202 that is similar or identical to the new search query 202 is also used for continually providing matching events 110 to the client device 116 that created the new search query 202.

Each entry 114 in the search query table 112 may therefore store the number of client devices 116 that have created the search query 202 corresponding to the entry 114 in question, and thus the number of client devices 116 that are retrieving matching events 110 from the corresponding search table 108. When entry 114 is created for a new search query 202 that is different than the search query 202 of any existing entry 114 in the search query table 112, the number of client devices 116 is initially set to one. Each time another client device 116 in effect subscribes to the corresponding search table 108 (i.e., each time another client device 116 creates the same search query 202), the number of client devices 116 in the entry 114 is incremented.

Similarly, when a client device 116 no longer subscribes to the search table 108 for a search query 202 (i.e., the client device 116 no longer retrieves matching events 110 from the search table 108), the number of client devices 116 in the corresponding entry 114 is decremented. When the number of client devices 116 reaches zero, the entry 114 is removed from the search query table 112, and the corresponding search job 122 and search table 108 are deleted. Therefore, when a search query 202 is removed at a client device 116, the client device 116 may decrement the number of client devices 116 in the corresponding entry 114. The search query management process 120 may periodically detect entries 114 for which the number of client devices 116 is zero, and remove their corresponding search jobs 122 and search tables 108. Furthermore, the client devices 116 may be able to retrieve the entries 114 for existing search queries 202 from the search query table 112, and display the search queries 202. Therefore, a user at a client device 116 may, instead of creating a new search query 202, reuse (i.e., in effect subscribe to) an existing search query 202 for which there is already a search job 122 and a search table 108. Using the same search table 108 and search job 122 to service multiple client devices 116 that have created the same search query 202, instead of having a different search table 108 and search job 122 for each client device 116, improves database performance.

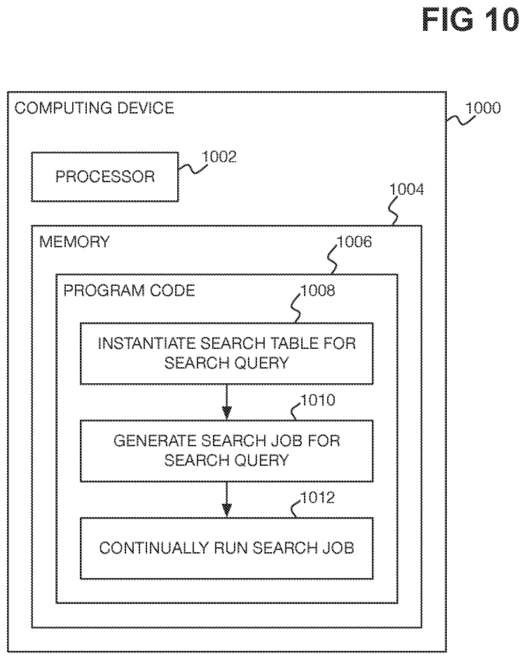

FIG. 10 shows an example computing device 1000 that can implement the search table device 118 (and thus may also implement the database device 102). The computing device 1000 includes a processor 1002 and memory 1004, which is an example of a non-transitory computer-readable data storage medium. The memory 1004 stores program code 1006 executable by the processor 1002 to perform processing, such as that which has been described above. For instance, the processing can include instantiating a search table 108 for a search query 202 (1008), generating a search job 122 for the search query 202 (1010), and continually running the search job 122 (1012) so that matching events 110 can be continually provided from the search table 108 as opposed to from the events table 104.

Techniques have been described herein that provide a database architecture which improves performance of search queries for which matching events are to be continually provided as new events are continually loaded into an events table. A search table is instantiated for a search query when the search query is generated, such that matching events are continually provided from the search table and not from the events table. A search job is also generated, and is continually run to retrieve new matching events from the events table and insert them into the search table. Continually providing the matching events from the search table as opposed to from the events table has been demonstrated to improve database performance.

We claim:

1. A non-transitory computer-readable data storage medium storing program code executable by a processor to perform processing comprising:
instantiating a search table for a search query for which matching events of a plurality of events stored in an events table are to be continually provided as new events are continually loaded into the events table, the matching events satisfying the search query, the search table to store the matching events;
generating a search job for the search query, the search job to be continually run to retrieve the matching events stored in the events table that are not already stored in the search table and to insert the retrieved matching events in the search table; and
continually running the search job, such that the matching events are continually provided from the search table and not from the events table.

2. The non-transitory computer-readable data storage medium of claim 1, wherein the processing further comprises:
detecting addition of an entry in a search query table, the entry corresponding to the search query,
wherein the search table for the search query is instantiated in response to detecting the addition of the entry corresponding to the search query in the search query table.

3. The non-transitory computer-readable data storage medium of claim 1, wherein a client computing device that generated the search query displays a user interface for the search query populated with the matching events from the search table,
wherein, as the search job is continually run to retrieve new matching events from the events table and to insert the new matching events in the search table, the client computing device continually retrieves the new matching events from the search table and not from the events table, and continually updates the user interface by automatically displaying the new matching events in the user interface.

4. The non-transitory computer-readable data storage medium of claim 1, wherein continually running the search job comprises, a first time the search job is run:
running the search job to retrieve the matching events stored in the events table that are newer than a specified newness threshold; and
inserting the retrieved matching events in the search table.

5. The non-transitory computer-readable data storage medium of claim 4, wherein continually running the search job further comprises, each of a plurality of times the search job is run other than the first time:
retrieving the matching events stored in the events table that are newer than a newest matching event already stored in the search table; and
inserting the retrieved matching events in the search table.

6. The non-transitory computer-readable data storage medium of claim 5, wherein inserting the retrieved matching events in the search table comprises:
dividing the retrieved matching events into a plurality of chunks; and
inserting the chunks of the retrieved matching events in parallel.

7. The non-transitory computer-readable data storage medium of claim 1, wherein the new events are continually loaded into the events table in batches at a loading time interval, and each event stored in the events table has a loading time indicating when the event was loaded into the events table,
and wherein continually running the search job comprises, each of a plurality of times the search job is run:
setting a maximum loading time to the loading time of a newest matching event already storing in the search table; and
retrieving each matching event stored in the events table that the loading time of which is more recent than the maximum loading time.

8. The non-transitory computer-readable data storage medium of claim 7, wherein continually running the search job further comprises, each of the plurality of times the search job is run:
inserting the retrieved matching events in the search table.

9. The non-transitory computer-readable data storage medium of claim 7, wherein continually running the search job further comprises, each of the plurality of times the search job is run:
retrieving each matching event stored in the events table that the loading time of which is no older than the maximum loading time and is more recent than the maximum loading time minus the loading interval; and
inserting the retrieved matching events in the search table that are not already in the search table.

10. The non-transitory computer-readable data storage medium of claim 1, wherein the new events are continually loaded into the events table in batches at a loading time interval, and each event stored in the events table has a loading time indicating when the event was loaded into the events table,
and wherein continually running the search job comprises:
setting a maximum loading time to the loading time of a newest matching event already stored in the search table;
retrieving each matching event stored in the events table that the loading time of which is more recent than the maximum loading time minus the loading interval; and
inserting the retrieved matching events in the search table that are not already in the search table.

11. The non-transitory computer-readable data storage medium of claim 1, wherein the new events are continually loaded into the events table in batches at a loading time interval, and each event stored in the events table has a loading time indicating when the event was loaded into the events table,
wherein the search table is instantiated such that the search table is partitioned, and new partitions are added to the search table as the search job is continually run, in correspondence with the loading time,
and wherein a plurality of partitions of the search table correspond to consecutive time periods, each partition storing the matching events for which the loading times are within a corresponding time period.

12. The non-transitory computer-readable data storage medium of claim 11, wherein the processing further comprises:
periodically determining whether the search table has a total number of partitions greater than a threshold; and
in response to determining that the total number of partitions is greater than the threshold, deleting the partition including the matching events that are oldest.

13. The non-transitory computer-readable data storage medium of claim 12, wherein the processing further comprises:
periodically determining whether a total number of the matching events stored in the search table is greater than a different threshold; and
in response to determining that the total number of the matching events stored in the search table is greater than the different threshold, deleting the partition including the matching events that are oldest.

14. The non-transitory computer-readable data storage medium of claim 1, wherein the search query is one of a plurality of different search queries, such that for each different search query a different search table is instantiated and a different search job is generated,
and wherein the different search jobs are continually run in parallel with one another.

15. A computing system comprising:
a database computing device configured to store:
an events table storing a plurality of events, where new events are continually loaded into the events table; and
a search table for a search query for which matching events of the events stored in the events table are to be continually provided as the new events are continually loaded into the events table, the matching events satisfying the search query, the search table storing the matching events; and
a first computing device having a processor and a memory storing program code executable by the processor to:
detect the search query, the search query generated at a client computing device that displays a user interface for the search query populated with the matching events from the search table;
in response to detecting the search query, instantiate the search table for the search query; and
generate a search job for the search query, the search job to be continually run to retrieve the matching events stored in the events table that are not already stored in the search table and to insert the retrieved matching events in the search table; and
continually run the search job, such that the matching events are continually provided from the search table and not from the events table,
wherein, as the search job is continually run to retrieve new matching events from the events table and to insert the new matching events in the search table, the client computing device continually retrieves the new matching events from the search table and not from the events table, and continually updates the user interface by displaying the new matching events in the user interface.

16. The computing system of claim 15, wherein the database computing device is a different device than the first computing device.

17. The computing system of claim 15, wherein the first computing device is the database computing device.

18. The computing system of claim 15, wherein the search query is one of a plurality of search queries, the search table is one of a plurality of search tables respectively corresponding to the search queries, and the database computing device is further configured to store a search query table storing the search queries,
wherein the search query table stores, for each search query, a maximum number of the matching events to be stored in the search table for the search query, a maximum number of partitions that the search table for the search query is to have, and a time period length of each partition,
wherein the new events are continually loaded into the events table in batches at a loading time interval, and each event stored in the events table has a loading time indicating when the event was loaded into the events table,
and wherein the search table for each search query is instantiated such that the search table is partitioned in correspondence with the loading time, and such that the partitions of the search table correspond to consecutive time periods of the time period length, each partition storing the matching events for which the loading times are within a corresponding time period.

19. The computing system of claim 15, wherein the new events are continually loaded into the events table in batches at a loading time interval, and each event stored in the events table has a loading time indicating when the event was loaded into the events table,
and wherein the search job is continually run by, each of a plurality of times the search job is run:
setting a maximum loading time to the loading time of a newest matching event already stored in the search table;
retrieving each matching event stored in the events table that the loading time of which is more recent than the maximum loading time;
retrieving each matching event stored in the events table that the loading time of which is no older than the maximum loading time and is more recent than the maximum loading time minus the loading interval; and
inserting the retrieved matching events in the search table that are not already in the search table.

20. A method comprising:
instantiating a search table for a search query for which matching events of a plurality of events stored in an events table are to be continually provided as new events are continually loaded into the events table, the matching events satisfying the search query, the search table to store the matching events;
generating a search job for the search query, the search job to be continually run to retrieve the matching events stored in the events table that are not already stored in the search table and to insert the retrieved matching events in the search table;
continually running the search job, such that the matching events are continually provided from the search table and not from the events table; and
continually updating a user interface for the search query as the matching events are provided from the search table,
wherein as the search job is continually run to retrieve new matching events from the events table and to insert the new matching events in the search table, the new matching events are automatically displayed in the user interface.
